(19) United States
(12) Patent Application Publication
(10) Pub. No.: US 2019/0363924 A1
(43) Pub. Date: Nov. 28, 2019

(54) BULK CREATION OF MANAGED FUNCTIONS IN A NETWORK THAT INCLUDES VIRTUALIZED NETWORK FUNCTION

(71) Applicant: Telefonaktiebolaget LM Ericsson (publ), Stockholm (SE)

(72) Inventors: Edwin TSE, Montreal (CA); Robert PETERSEN, Linköping (SE); Jan GROENENDIJK, Athlone (IE)

(21) Appl. No.: 16/477,755

(22) PCT Filed: Dec. 28, 2017
(86) PCT No.: PCT/IB2017/058482

§ 371 Date: Jul. 12, 2019

Related U.S. Application Data
(60) Provisional application No. 62/446,105, filed on Jan. 13, 2017.

(51) Int. Cl. H04L 12/24; G06F 9/455

(52) U.S. Cl. CPC H04L 41/0233; G06F 2009/45595; G06F 9/45558; H04L 41/0806

(57) ABSTRACT

A method, an Element Manager (EM), a Network Manager (NM), an EM node, and a NM node configured to deploy virtualized Managed Elements (vMEs) in a network. The method includes receiving, from an NM, information that includes a set of Virtualized Network Function (VNF) identifications (IDs), each VNF ID of the set of VNF IDs representing an instantiated VNF, each instantiated VNF corresponding to a desired vME, receiving, from the NM, instructions to deploy the network in accordance with the information, creating a set of Managed Object Instances (MOIs) based on the information, receiving notification when a VNF is instantiated and begins execution, the notification including a corresponding VNF ID, and if the corresponding VNF ID matches a VNF ID from the set of VNF IDs, enabling an operational state of an MOI from the set of MOIs corresponding to the matched VNF ID.

### TECHNICAL FIELD

Wireless communication and in particular, a method, network manager, and element manager for creation of managed functions for virtualized managed elements.

### BACKGROUND

Modern telecommunication networks contain an ever increasing variety of proprietary hardware. The launch of new services or network reconfiguration demands the installation of yet more equipment that in turn requires additional floor space, power, trained maintenance staff, etc. As the innovation cycles continue to accelerate, hardware-based appliances rapidly reach the end of their functional life. Simply having a hard-wired network with boxes dedicated to single functions is not the optimal way to achieve dynamic service offerings.

In the same way that applications are supported by dynamically configurable and fully automated cloud environments, network design and implementation must also become more agile and able to respond automatically and on-demand to the dynamic needs of the traffic and services running over it. The European Telecommunications Standards Institute (ETSI) introduced Network Functions Virtualization (NFV), which aims to address these problems by leveraging standard information technology (IT) virtualization technology to consolidate many telecom network equipment types onto industry standard high volume servers, switches and storage, which could be located in, for example, Datacenters, Network Nodes and in the end user premises. The NFV architecture framework is described in ETSI Group Specification (GS) NFV 002 V1.2.1.

NFV envisions the implementation of Network Functions (NFs) as software-only entities that run over the NFV Infrastructure (NFVI). FIG. 1 illustrates an example of a high-level NFV framework. Three main working domains are identified in NFV. Virtualized Network Functions (VNFs) are the virtual software implementation capable of running over the NFVI. The NFVI includes the diversity of physical resources and how these physical resources can be virtualized. NFVI supports the execution of the VNFs. The NFV Management and Orchestration (NFV-MANO) covers the orchestration and lifecycle management of physical and/or software resources that support the infrastructure virtualization, and the lifecycle management of VNFs. The NFV-MANO focuses on all virtualization-specific management tasks necessary in the NFV framework. Details about the NFV-MANO are described in ETSI Group Specification (GS) NFV-MAN 001 V1.1.1.

FIG. 2 illustrates a conventional NFV-MANO architectural framework. The NFV-MANO architectural framework identifies a number of NFV-MANO functional blocks. These include a Virtualized Infrastructure Manager (VIM), which is responsible for controlling and managing the NFVI's computer, storage and network resources, typically within one operator's Infrastructure Domain. Another functional block of the NFV-MANO architecture is the VNF Manager (VNFM), which is responsible for the lifecycle management of VNF instances, e.g., instantiation, software upgrades, scaling in/out/up/down, etc. Each VNF instance is assumed to have an associated VNF Manager. A VNF manager may be assigned the management of a single VNF instance, or the management of multiple VNF instances of the same type or of different types.

Another functional block of the NFV-MANO architectural framework is the NFV Orchestrator (NFVO). The NFVO has two primary responsibilities. The first responsibility is the orchestration of NFVI resources across multiple VIMs, fulfilling the resource orchestration functions. The second responsibility is the lifecycle management of Network Services, e.g., on-boarding new Network Services and VNF Packages, management of the instantiation of VNFMs where applicable, management of the instantiation of VNFs in coordination with VNFMs, etc., and fulfilling the Network Service Orchestration functions. FIG. 2 also illustrates the Operational Support System (OSS)/Business Support System (BSS) or Network Manager (NM), which is in communication with one or more element managers (EMs). The NM provides a package of end-user functions with the responsibility for management of the network as supported by the EMs. The EMs provide a package of end-user functions for the management of a set of closely related types of Network Elements.

The virtualized managed element (vME) is represented by two sets of software objects in management systems. One set of software objects (called Managed Object Instances or MOIs) is maintained by the EM. The other set of software objects (called VNF instances) is maintained in the VNFM. Existing solutions treat the process of the former set creation and the process of the latter set creation to be separate processes. Creating MOIs and VNF instances individually, i.e., one by one, does not scale well when there is a need to create a large number of MOIs and VNF instances. For example, not only is the process longer and involves repetitive steps, but it is also more prone to errors, which ultimately may induce inconsistencies between the set of VNF instances held in the VNFM and the set of MOIs of the EM.

### SUMMARY

Some embodiments advantageously provide a method, network manager, and element manager for bulk creation of managed functions in a network that includes virtualized network functions and which improves resource efficiencies for such networks.

The disclosure includes several embodiments related to a network manager, an element manager and methods in the network manager and the element manager as described herein.

According to one aspect, a method, in an Element Manager (EM) for deploying virtualized Managed Elements (vMEs) in a network is provided. The method includes receiving, from a Network Manager (NM) information that includes a set of Virtualized Network Function (VNF) identifications (IDs) each VNF ID of the set of VNF IDs representing an instantiated VNF, each instantiated VNF corresponding to a desired vME; receiving, from the NM, instructions to deploy the network in accordance with the information; creating a set of Managed Object Instances (MOIs) based on the information; receiving notification when a VNF is instantiated and begins execution, the notification including a corresponding VNF ID; and if the corresponding VNF ID matches a VNF ID from the set of VNF IDs: enabling an operational state of an MOI from the set of MOIs corresponding to the matched VNF ID.

According to this aspect, in some embodiments, the method further includes notifying the NM of the MOI whose operational state is enabled. In some embodiments, the method further includes returning operational control for deploying the network to the NM when all of the information has been processed. In some embodiments, each enabled MOI is linked to a corresponding VNF instance.

According to another aspect, an Element Manager (EM) for deploying virtualized Managed Elements (vMEs) in a network is provided. The EM includes a communications interface and processing circuitry. The communications interface is configured to: receive, from a Network Manager (NM) information that includes a set of Virtualized Network Function (VNF) identifications (IDs) each VNF ID of the set of VNF IDs representing an instantiated VNF, each instantiated VNF corresponding to a desired vME; and receive, from the NM, instructions to deploy the network in accordance with the information. The processing circuitry is configured to: create a set of Managed Object Instances (MOIs) based on the information; and upon the communications interface receiving notification when a VNF is instantiated and begins execution, the notification including a corresponding VNF ID, if the corresponding VNF ID matches a VNF ID from the set of VNF IDs: enable an operational state of an MOI from the set of MOIs corresponding to the matched VNF ID.

According to this aspect, in some embodiments, the processing circuitry is further configured to notify the NM, via the communications interface, of the MOI whose operational state is enabled. In some embodiments, the processing circuitry is further configured to return operational control for deploying the network to the NM when all of the information has been processed. In some embodiments, each enabled MOI is linked to a corresponding VNF instance.

According to yet another aspect, a method, in a Network Manager (NM) for deploying virtualized Managed Elements, vME, in a network is provided. The method includes requesting a Network Functions Virtualization Orchestrator (NFVO) to instantiate a plurality of Virtualized Network Functions, VNFs, each of the plurality of VNFs corresponding to a desired vME; receiving, from the NFVO a set of VNF identifications (IDs) each VNF ID of the set of VNF IDs corresponds to an instantiated VNF; updating a file by associating the received VNF IDs with corresponding Managed Object Instances (MOIs); and instructing an Element Manager (EM) to deploy the network based on the information in the file.

According to this aspect, in some embodiments, the method further includes receiving a notification from the EM, the notification indicating at least one MOI whose operational state is enabled. In some embodiments, each enabled MOI is linked to a corresponding VNF instance. In some embodiments, the method further includes resuming operational control for deploying the network when the EM has processed all of the information in the file.

According to another aspect, a Network Manager (NM) for deploying virtualized Managed Elements (vMEs) in a network is provided. The NM includes a communications interface and processing circuitry. The communications interface is configured to: request a Network Functions Virtualization Orchestrator (NFVO) to instantiate a plurality of Virtualized Network Functions (VNFs) each of the plurality of VNFs corresponding to a desired vME; and receive, from the NFVO, a set of VNF identifications (IDs) each VNF ID of the set of VNF IDs corresponding to an instantiated VNF. The processing circuitry is configured to: update a file by associating the received set of VNF IDs with corresponding Managed Object Instances (MOIs); and instruct, via the communications interface, an Element Manager (EM) to deploy the network based on information in the file.

According to this aspect, in some embodiments, the communications interface is further configured to receive a notification from the EM, the notification indicating at least one MOI whose operational state is enabled. In some embodiments, each enabled MOI is linked to a corresponding VNF instance. In some embodiments, the processing circuitry is further configured to resume operational control for deploying the network when the EM has processed all of the information in the file.

According to another aspect, an Element Manager (EM) for deploying virtualized Managed Elements (vMEs) in a network is provided. The EM includes a communications interface module and a Managed Object Instance, MOI, enabling module. The communications interface is configured to: receive, from a Network Manager (NM) information that includes a set of Virtualized Network Function (VNF) identifications (IDs) each VNF ID of the set of VNF IDs representing an instantiated VNF, each instantiated VNF corresponding to a desired vME; and receive, from the NM, instructions to deploy the network in accordance with the information. The MOI enabling module is configured to: create a set of MOIs based on the information; and upon the communications interface module receiving notification when a VNF is instantiated and begins execution, the notification including a corresponding VNF ID, if the corresponding VNF ID matches a VNF ID from the set of VNF IDs: enable an operational state of an MOI from the set of MOIs corresponding to the matched VNF ID.

According to another aspect, a Network Manager (NM) for deploying virtualized Managed Elements (vMEs) in a network is provided. The NM includes a communications interface module and a VNF ID Managed Object Instance, MOI, pairing module. The communications interface is configured to: request a Network Functions Virtualization Orchestrator (NFVO) to instantiate a plurality of Virtualized Network Function (VNFs) each of the plurality of VNFs corresponding to a desired vME; and receive, from the NFVO, a set of VNF identifications (IDs) each VNF ID of the set of VNF IDs corresponding to an instantiated VNF. The VNF ID MOI pairing module is configured to: update a file by associating the received VNF IDs with corresponding MOIs; and instruct, via the communications interface module, an Element Manager (EM) to deploy the network based on information in the file.

According to yet another aspect, an Element Manager (EM) node, configured to deploy virtualized Managed Elements (vMEs) in a network, the EM node running in a cloud computing environment and the EM node configured to: receive, from a Network Manager (NM) information that includes a set of Virtualized Network Function (VNF) identifications (IDs) each VNF ID of the set of VNF IDs representing an instantiated VNF, each instantiated VNF corresponding to a desired vME; receive, from the NM, instructions to deploy the network in accordance with the information; create a set of Managed Object Instances (MOIs) based on the information; receive notification when a VNF is instantiated and begins execution, the notification including a corresponding VNF ID; and if the corresponding VNF ID matches a VNF ID from the set of VNF IDs: enable an operational state of an MOI from the set of MOIs corresponding to the matched VNF ID.

According to this aspect, in some embodiments, the EM node is further configured to notify the NM of the MOI whose operational state is enabled. In some embodiments, the EM node is further configured to return operational control for deploying the network to the NM when all of the information has been processed. In some embodiments, each enabled MOI is linked to a corresponding VNF instance.

According to another aspect, a Network Manager (NM) node, configured to deploy virtualized Managed Elements (vMEs) in a network is provided. The NM node runs in a cloud computing environment and the NM node is configured to: request a Network Functions Virtualization Orchestrator (NFVO) to instantiate a plurality of Virtualized Network Functions (VNFs) each of the plurality of VNFs corresponding to a desired vME; receive, from the NFVO, a set of VNF identifications (IDs) each VNF ID of the set of VNF IDs corresponding to an instantiated VNF; update a file by associating the received VNF IDs with corresponding Managed Object Instances (MOIs); and instruct, via the communications interface, an Element Manager (EM) to deploy the network based on information in the file.

According to this aspect, in some embodiments, the NM node is further configured to receive a notification from the EM, the notification indicating at least one MOI whose operational state is enabled. In some embodiments, each enabled MOI is linked to a corresponding VNF instance. In some embodiments, the NM node is further configured to resume operational control for deploying the network when the EM has processed all of the information in the file.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a block diagram of a typical high-level NFV framework;

FIG. 2 is a block diagram of an NFV-MANO architectural framework with reference points;

FIG. 3 is a block diagram of an exemplary Network Manager configured to deploy vMEs in a network in accordance with an embodiment of the present disclosure;

FIG. 4 is a block diagram of an exemplary Element Manager configured to deploy vMEs in a network in accordance with an embodiment of the present disclosure;

FIG. 5 is systems diagram illustrating functional elements in a virtualized network and the steps performed by the functional elements in accordance with an embodiment of the present disclosure;

FIG. 6 is a flow diagram illustrating an exemplary method performed by a Network Manager to deploy vMEs in a network in accordance with an embodiment of the present disclosure;

FIG. 7 is a flow diagram illustrating an exemplary method performed by an Element Manager to deploy vMEs in a network in accordance with an embodiment of the present disclosure;

FIG. 8 is a block diagram of an alternate Network Manager configured to deploy vMEs in a network in accordance with an embodiment of the present disclosure;

FIG. 9 is a block diagram of an alternate Element Manager configured to deploy vMEs in a network in accordance with an embodiment of the present disclosure; and

FIG. 10 is a diagram of a cloud computing environment in accordance with an embodiment of the present disclosure.

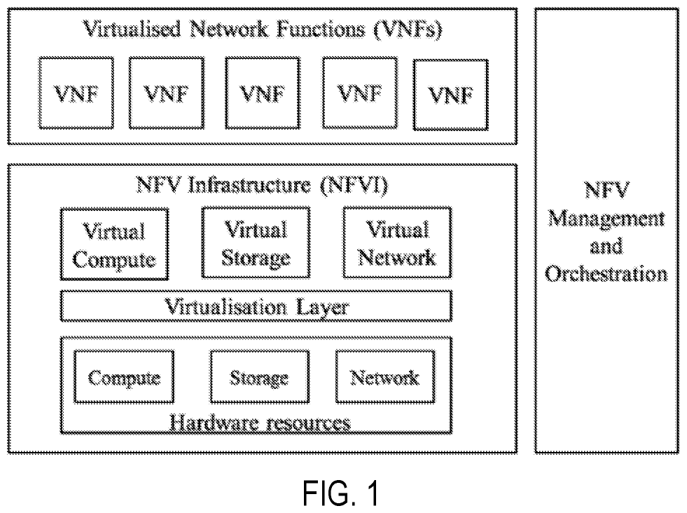

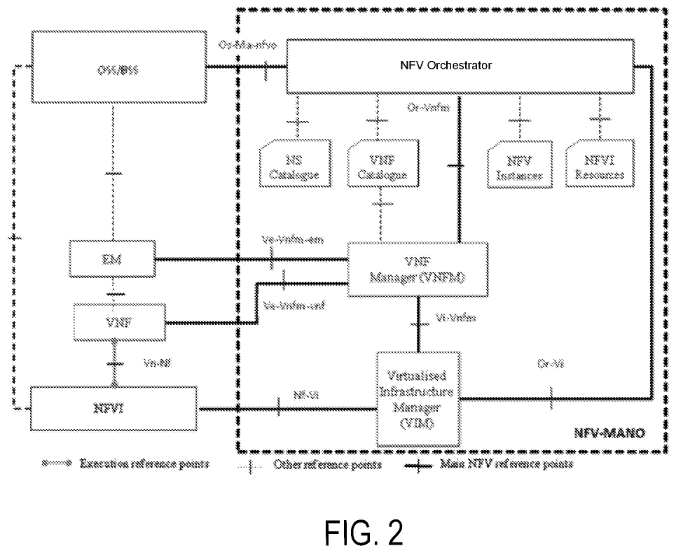

### DETAILED DESCRIPTION

Before describing in detail exemplary embodiments, it is noted that the embodiments reside primarily in combinations of apparatus components and processing steps related to bulk creation of managed functions in a network that includes virtualized network function. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

Embodiments of the present disclosure provide a method, a network manager, and an element manager configured to deploy a number of Managed Elements (MEs) that are virtualized. The virtualized ME is represented by two sets of software objects. One set of software objects (called Managed Object Instances or MOIs) is maintained by the EM. The other set of software objects (called VNF instances) is maintained in the VNFM. For proper and efficient management of a virtualized ME, the two sets of objects may be in place in the respective management system, i.e., in the EM and the VNFM. Embodiments of the present disclosure combine the process of VNF instance creation and the MOI creation as an atomic process, from the perspective of the operator and the NM (e.g., OSS/BSS). Embodiments of the present disclosure also handles the creation of MOIs in bulk (i.e., large quantity), and can associate all created MOIs with corresponding created VNF instances from the perspectives of the operator and the NM (OSS/BSS). Using the methods and arrangements disclosed herein, the operator and NM can view the process of MOI creation and VNF instance creation as an atomic process, in that when the process is successfully completed, the created MOI will have a link to the created VNF instances. Further, using embodiments of the proposed solution, the operator and NM can, instead of deploying one virtualized ME at a time, deploy multiple virtualized MEs at once, and the MOIs created would be linked with the corresponding VNF instances created.

Unlike non-virtualized MEs, virtualized MEs are represented by two sets of software objects housed in two different management systems. The former, housed in the EM, represents the application aspects or properties of the ME. The latter, housed in the VNFM, represents the virtualization aspects or properties of the ME. In order to facilitate the life cycle management of a virtualized ME, the creation of these two representations may be treated as one, i.e., may both be successfully and properly created as part of the same process in order to avoid some of the problems of the prior art, such as those discussed herein above. At least one feature of the present disclosure supports such atomicity.

Assuming that non-virtualized network elements will be divided into smaller components so that the components can be individually virtualized, and assuming that there would be more virtualized MEs in a Cloud environment, such as across the Internet, embodiments of the present disclosure advantageously provide a feature that supports the operator and the NM, i.e., where instead of deploying one virtualized ME at a time, multiple virtualized MEs are deployed at once and all created MOIs are associated with corresponding created VNF instances.

As used herein, relational terms, such as “first,” “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication

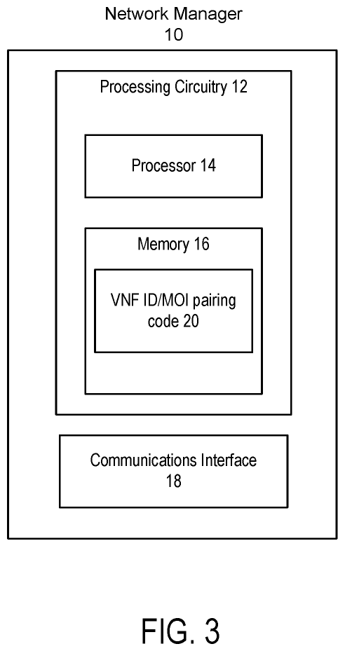

FIG. 3 is a block diagram of an example network manager (NM) 10, configured to perform some of the aspects of the present disclosure as described in detail below. NM 10 may provide a package of end-user functions with the responsibility of management of a network. The functions provided by NM 10 may be performed by processing circuitry 12, which includes processor 14 and memory 16. NM 10 may also communicate with other elements in the network via a communications interface 18. In addition to a traditional processor and memory, processing circuitry 12 may comprise integrated circuitry for processing and/or control, e.g., one or more processors and/or processor cores and/or FPGAs (Field Programmable Gate Array) and/or ASICs (Application Specific Integrated Circuitry). Processor 14 may be configured to access (e.g., write to and/or reading from) memory 16, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Such memory 16 may be configured to store code executable by processor 14 and/or other data, e.g., data pertaining to communication, e.g., configuration and/or address data of nodes, etc.

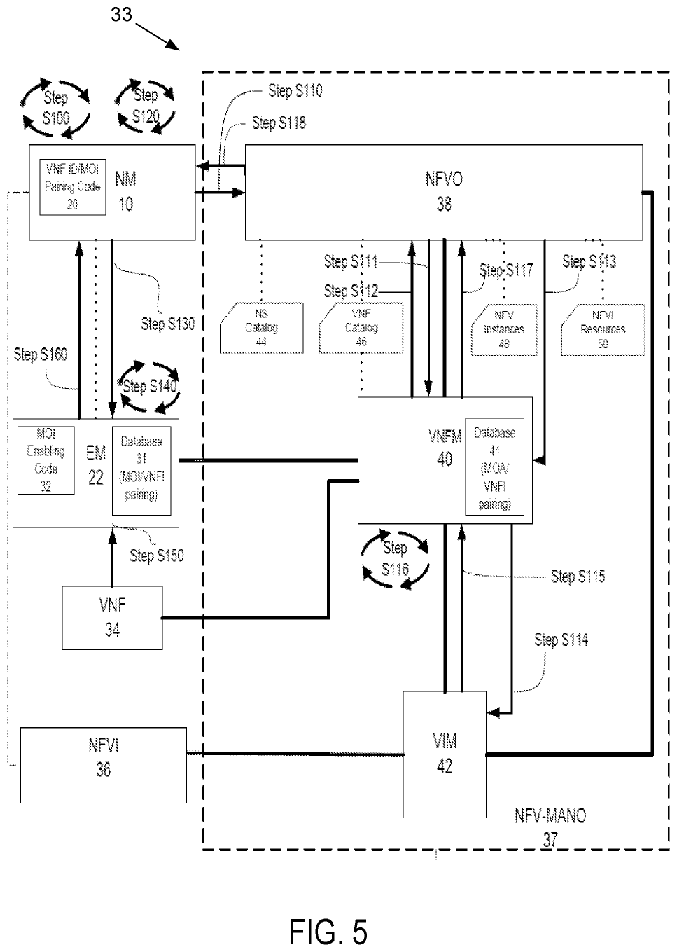

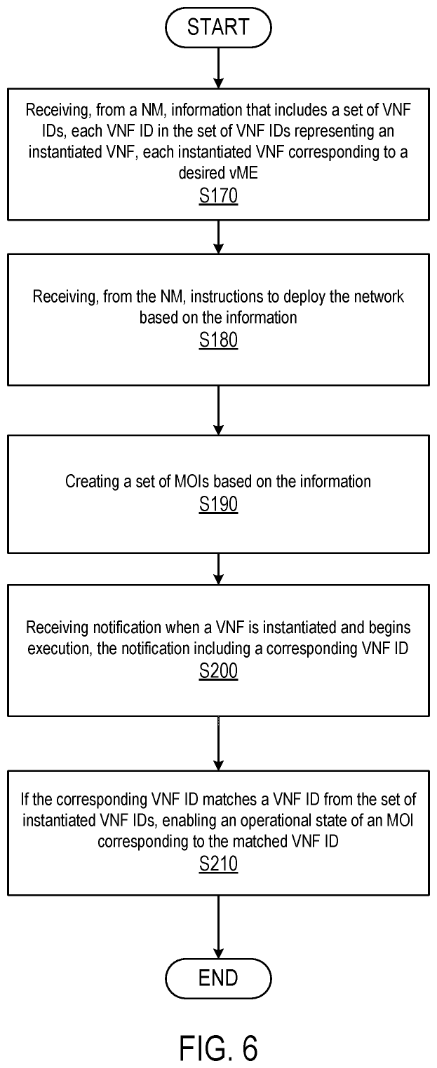

Processing circuitry 12 may be configured to control any of the methods and/or processes described herein and/or to cause such methods and/or processes to be performed, e.g., by NM 10 functions described herein. NM 10 includes memory 16 that is configured to store data, programmatic software code and/or other information described herein. In one or more embodiments, memory 16 is configured to store VNF/MOI pairing code 20. For example, VNF/MOI pairing code 20 causes processor 14 to perform some or all of the processes performed by NM 10 discussed in detail below with respect to FIG. 5 and FIG. 6 and embodiments discussed herein. It is noted that a single processing circuitry 12 can provide multiple NMs 10.

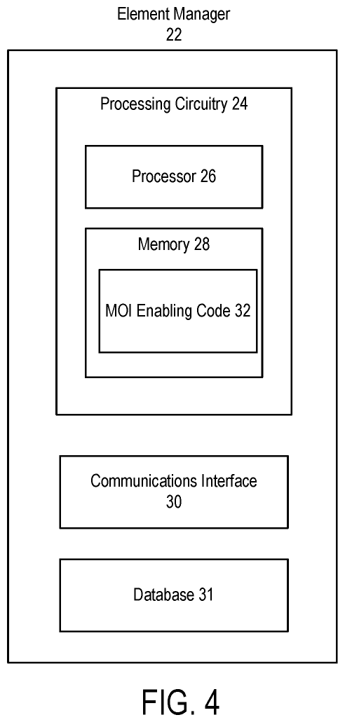

FIG. 4 is a block diagram of an example element manager (EM) 22, configured to perform some of the aspects of the present disclosure. EM 22 may provide a package of end-user functions for management of a set of closely related types of network elements. For example, EM 22 may be responsible for the co-management of some aspects, i.e., the application aspects, of the VNFs of the network. The functions provided by EM 22 may be performed by processing circuitry 24, which includes processor 26 and memory 28. EM 22 may also communicate with other elements in the network via a communications interface 30. EM 22 may also either include a database 31 or have access to database 31. In addition to a traditional processor and memory, processing circuitry 24 may comprise integrated circuitry for processing and/or control, e.g., one or more processors and/or processor cores and/or FPGAs (Field Programmable Gate Array) and/or ASICs (Application Specific Integrated Circuitry). Processor 26 may be configured to access (e.g., write to and/or reading from) memory 28, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Such memory 28 may be configured to store code executable by processor 26 and/or other data, e.g., data pertaining to communication, e.g., configuration and/or address data of nodes, etc.

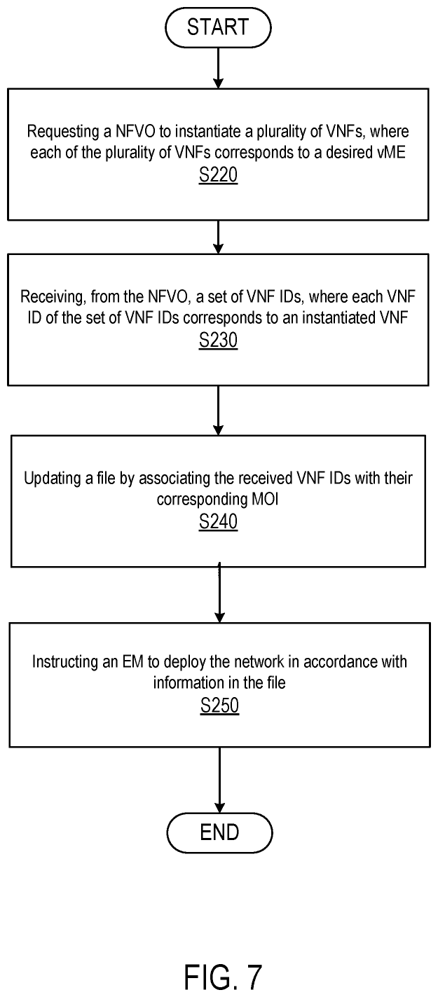

Processing circuitry 24 may be configured to control any of the methods and/or processes described herein and/or to cause such methods and/or processes to be performed, e.g., by EM 22 functions described herein. EM 22 includes memory 28 that is configured to store data, programmatic software code and/or other information described herein. In one or more embodiments, memory 28 is configured to store MOI Enabling code 32. For example, MOI Enabling code 32 causes processor 26 to perform some or all of the processes performed by EM 22 discussed in detail below with respect to FIG. 5 and FIG. 7 and embodiments discussed herein. It is noted that a single processing circuitry 24 can provide multiple EMs 22.

FIG. 5 is a diagram illustrating an exemplary embodiment of a system in accordance with the present disclosure. FIG. 5 depicts an NFV architectural framework 33 that includes a plurality of functional elements, many of which have been described above. Included in framework 33 is NM 10, the components of which are described above and depicted in FIG. 3. NM 10 includes the necessary hardware and software needed to support activities which serve to operate a telecommunication network and to provision and maintain customer services as supported by one or more EMs 22. FIG. 5 also depicts EM 22, the components of which are described above and depicted in FIG. 4. Although, for simplicity, only one EM 22 is depicted in FIG. 5, the present disclosure is not limited in this regard and framework 33 may include any number of EMs 22. EM 22 may manage some of the application aspects of virtualized network functions (VNFs) 34. Network Function Virtualization Infrastructure (NFVI) 36 includes the physical resources to support the execution of the software implementation of the VNFs 34.

FIG. 5 also includes NFV Management and Orchestration (NFV-MANO) 37, which, as described above, is responsible for the overall management of physical and software resources that support infrastructure virtualization. NFV-MANO 37 includes NFV Orchestrator (NFVO) 38, a VNF Manager (VNFM) 40, and a Virtualized Infrastructure Manager (VIM) 42. NFVO 38 may be responsible for the orchestration of one or more Network Services (NSs) as well as the orchestration of NFVI resources across multiple VIMs 42. NFVO 38 may provide for the onboarding of new Network Services (NSs) and VNF packages and therefore has access to a NS catalog 44 including the different NSs and VNF catalog 46 including the set of VNF packages. NFVO 38, responsible for orchestration of the NS/VNF instances, maintains an NFV instances repository 48 and NFVI Resources repository 50. NFVO 38 may provide NS lifecycle management including instantiation, scale-out and scale in performance measurements, even correlation and termination.

The responsibilities of VNFM 40 may include the lifecycle management (i.e., the instantiation and co-management, along with EM 22) of the VNF 34 instances. VNFM 40 may also adopt overall coordination and adaptation roles for configuration and event reporting between NFVI 36/VIM 42 and EM 22. For simplicity, although only one VNFM 40 is shown, the present disclosure is not limited to a specific number of VNFMs 40 and NFV-MANO 37 may include any number of VNFMs 40. VIM 42 may manage and control the resources of NFVI 36, and, in some embodiments, assist VNFM 40 with the instantiation of the VNFs 34. VIM 42 may also provide collection and forwarding of performance measurements and events to other components in NFV-MANO 37.

In one embodiment of the present disclosure, a number of pre-deployment assumptions are identified. For example, the operator of the network is in possession of the network planned data and is ready for its implementation. The planned data specifies a to-be-deployed network of Managed Elements (MEs) and vMEs. During the VNF instantiation process and Physical Network Function (PNF) deployment process, the VNF 34 and PNF are given the managing Internet Protocol (IP) address of EM 22 or the name of the EM 22 and sufficient information to access a directory server that can match the EM name to the EM's IP address, such that VNF 34 or the PNF can request the directory server to identity the EM name based on the EM's IP address.

In one embodiment, as a pre-condition to deployment, the operator is aware of the number and kinds of MEs and vMEs desired. For each desired ME, the operator may know the type of PNF needed. The operator may obtain this knowledge, for example, from the ME vendor who implemented the ME using one PNF. For each desired vME, the operator knows the number and the types of VNFs 34 needed. The operator may obtain this knowledge, for example, from the vME vendor who implemented the vME using VNFs 34.

The deployment process may begin when the operator decides to deploy a network of MEs (and their types) and vMEs (and their types). The operator may construct a “Bulk Configuration Data File” (“File”) that captures one Managed Object class instance (MOI) representing one desired ME and/or one or more MOIs representing desired vMEs. In another embodiment, the “Bulk Configuration File” captures a plurality of MOIs, where each MOI of the plurality of MOIs represents a corresponding vME.

Referring to FIG. 5, in one exemplary process of the present disclosure, the operator instructs NM 10 to implement the network using information of the File (Step S100). NM 10, based on information in the File and the information described above in the pre-conditions to deployment, sends NFVO 38 an “update network service operation request” indicating that NM 10 would like a new VNF instance to be placed into an existing network service instance (Step 5110). NFVO 38 then sends VNFM 40 a “create NVF identifier operation” request (Step S111). VNFM 40 had created the VNF instance in an instance tree, which contains multiple VNF instances, and which is stored in database 41. Note that, in one embodiment, database 41 may be a part of VNFM 40 and, in another embodiment, VNFM 40 may have access to database 41, which is separate and apart from VNFM 40. VNFM 40 assigns an identifier or identification (ID) to this VNF instance. The operation state of this VNF instance is “NOT INSTANTIATED.” The actual VNF software image is not yet running anywhere.

Continuing with the exemplary process, VNFM 40 may respond to NFVO 38 with an “operation is successful” message as well as the VNF instance identifier (Step S112). NFVO 38 may send VNFM 40 an “instantiate VNF operation” message (Step S113). One of the input parameters may be the VNF instance identifier. VNFM 40 may then send VIM 42 a request asking VIM 42 to allocate resources (e.g., computing resources) to run the VNF 34 (Step S114). VIM 42 may download the VNF software image stored in VNF catalog 46 and start execution of VNF 34. VIM 42 may respond to VNFM 40 that the operation was successful (Step S115). VNFM 40 may change the state of the VNF instance from NOT INSTNTIATED to INSTANTIATED (Step S116). VNFM 40 may respond positively to NFVO 38, informing NFVO 38 that the VNF instance has been instantiated (Step S117). NFVO 38 may respond to NM 10 with an instantiated PNF ID for each ME wanted and a set of instantiated VNF IDs for each vME wanted (Step S118). When the VNF instance has been instantiated, NFV Instances repository 48 and NFVI Resources repository 50 may be changed, i.e., a new entry indicating VNF 34 is inserted in NFV Instances repository 48 and a new entry indicating the compute resources supporting VNF 34 is inserted in NFVI Resources repository 50.

NM 10 may update the File by capturing the received PNF ID in an attribute, called, for example, assigned-ID, of the corresponding MOI and by capturing the received VNF ID(s) in an attribute, called, for example, assigned-ID, of the corresponding MOI (Step S120). NM 10 may then instruct EM 22 to deploy the network in accordance with the File information (Step S130). EM 22 then creates a set of MOIs in database 31 in accordance with the File information (Step S140). For an MOI representing a PNF, the MOI's assigned-ID attribute has the PNF ID. The MOI operational state may be set to Disabled. For an MOI representing a VNF 34, the MOI's assigned-ID attribute has the VNF ID. The MOI operational state may be set to Disabled.

EM 22 may then be notified when a VNF 34 and/or a PNF is instantiated and starts to execute (Step S150). When a PNF is instantiated and starts to execute, the PNF may notify EM 22 of its (the PNF's) presence indicating its own PNF ID and its address. When a VNF 34 is instantiated and starts to execute, the VNF 34 may notify EM 22 of its (the VNF's) presence indicating its own VNF ID and its address. EM 22, on reception of notification bearing the VNF ID about a VNF presence, searches database 31 for the MOI whose assigned-ID attribute value is same as the VNF ID received. When found, the MOI operational state may be changed to Enabled. EM 22, on reception of notification bearing the PNF ID about a PNF presence, searches in database 31 for the MOI whose assigned-ID attribute value is same as the PNF ID received. When found, the MOI operational state may be changed to Enabled. EM 22 may then notify NM 10 of the MOI whose operational state is Enabled (Step S160). At this point, the EM 22 MOIs and the VNFM 40 VNF instances are set up, the EM 22 and VNFM 40 are each aware of the VNF 34 address, the VNF 34 knows the address of its managing EM 22 and VNFM 40, and the EM 22 and VNFM 40 can each communicate with VNF 34 for management purposes. In other words, the EM database 31 and the VNFM database 41 containing the tree of VNF instances may be synchronized with each other and may each contain the enabled MOIs and their corresponding VNF instances.

FIG. 6 is a flow diagram of an exemplary process, in an EM 22, for deploying virtualized vMEs in a network. In one embodiment, communication interface 30 receives, from NM 10, information that includes a set of VNF IDs, each VNF ID in the set of VNF IDs representing an instantiated VNF, each instantiated VNF corresponding to a desired vME (Block S170), and receives from the NM 10, instructions to deploy the network based on the information (Block S180). Processor 26 of EM 22 creates a set of MOIs in accordance with the information (Block S190). EM 22 receives notification when a VNF 34 is instantiated and begins execution, the notification including a corresponding VNF ID (Block S200). If processor 26 determines that the corresponding VNF ID matches a VNF ID from the set of VNF IDs, processor 26, in conjunction with MOI enabling code 32, enables an operational state of the MOI from the set of MOIs corresponding to the matched VNF ID (Block S210).

In another embodiment, the method further includes notifying the NM 10 of the MOI whose operational state is enabled. In another embodiment, the method further includes returning operational control for deploying the network to the NM 10 when all of the information has been processed. In another embodiment, each enabled MOI is linked to a corresponding VNF instance.

FIG. 7 is a flow diagram of an exemplary process, in an NM 10, for deploying vMEs in a network. In one embodiment, communications interface 18 of NM 10 requests NFVO 38 to instantiate at least one VNF 34, where each of the at least one VNF 34 corresponds to a desired vME (Block 5220) and receives back, from the NFVO, 38 a set of VNF IDs, where each VNF ID of the set of VNF IDs corresponds to an instantiated vME (Block S230). Processor 14, in conjunction with VNF ID/MOI pairing code 20, updates a file by associating the received VNF IDs with their corresponding MOI (Block S240), and instructs an EM 22 to deploy the network based on the information in the file (Block S260).

In another embodiment, the method further includes receiving, by communications interface 18, a notification from EM 22, the notification indicating at least one MOI whose operational state is enabled. In another embodiment, the method further includes resuming operational control for deploying the network when EM 22 has processed all of the information in the file. In another embodiment, each enabled MOI is linked to a corresponding VNF instance.

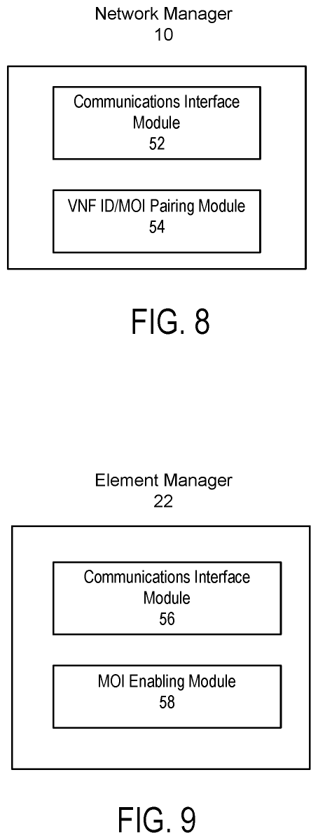

FIG. 8 is a block diagram of an alternate NM 10 for deploying virtualized vMEs in a network. In the alternate embodiment, NM 10 includes a communications interface module 52 configured to request NFVO 38 to instantiate a plurality of VNFs 34, where each of the plurality of VNF 34s corresponds to each desired vME, and receive, from NFVO 38, a set of VNF IDs, where each VNF ID of the set of VNF IDs corresponds to an instantiated VNF. NM 10 also includes a VNF ID/MOI pairing module 54 configured to update a file associating the received VNF IDs with their corresponding MOI, and instruct, via communications interface module 52, an EM 22, to deploy the network in accordance with information in the file.

FIG. 9 is a block diagram of an alternate EM 22 for deploying vMEs, in a network. In the alternate embodiment, EM 22 includes a communications interface module 56 configured to receive, from an NM 10, information that includes a set of VNF IDs, each VNF ID in the set of VNF IDs representing an instantiated VNF, each instantiated VNF corresponding to a desired vME, and receive, from NM 10, instructions to deploy the network in accordance with the information. EM 22 also includes an MOI enabling module 58 configured to create a set of MOIs in accordance with the information. Upon communications interface module 56 receiving notification when a VNF 34 is instantiated and begins execution, the notification including a corresponding VNF ID, if the corresponding VNF ID matches a VNF ID from the set of instantiated VNF IDs. MOI enabling module 58 is configured to enable an operational state of the MOI from the set of MOIs corresponding to the matched VNF ID.

In other embodiments, NM 10 and EM 22 are configured to operate in a cloud-based environment such as, for example, the Internet. In one embodiment, an EM node (e.g., EM 22) configured to deploy vMEs in a network is provided. The EM node may run in a cloud computing environment providing processing circuits (e.g., processing circuitry 24 and/or processor 26) and memory (e.g., memory 28) for running the node, the memory containing instructions executable by the processing circuits. The EM node may be configured to receive, from a NM 10, information that includes a set of VNF IDs, each VNF ID of the set of VNF IDs representing an instantiated VNF 34, each instantiated VNF corresponding to a desired vME, receive, from the NM 10 instructions to deploy the network in accordance with the information, create a set of MOIs based on the information, and receive notification when a VNF 34 is instantiated and begins execution, the notification including a corresponding VNF ID. If the corresponding VNF ID matches a VNF ID from the set of VNF IDs, the EM node is further configured to enable an operational state of an MOI from the set of MOIs corresponding to the matched VNF ID.

In another embodiment, the EM node is further configured to notify the NM 10 of the MOI whose operational state is enabled. In another embodiment, the EM node is further configured to return operational control for deploying the network to the NM 10 when all of the information has been processed. In another embodiment, each enabled MOI is linked to a corresponding VNF instance.

In yet another embodiment, a NM node (e.g., NM 10) configured to deploy vMEs in a network is provided. The NM node runs in a cloud computing environment providing processing circuits (e.g., processing circuitry 12 and/or processor 14) and memory (e.g., memory 16) for running the node, the memory containing instructions executable by the processing circuits. The NM node is configured to request a NFVO 38 to instantiate a plurality of VNFs 34, where each of the plurality of VNFs 34 corresponds to each desired vME, receive, from the NFVO 38, a set of VNF IDs, where each VNF ID of the set of VNF IDs corresponds to an instantiated VNF 34, update a file by associating the received VNF IDs with their corresponding MOIs, and instruct, an EM 22 to deploy the network based on information in the file.

In another embodiment, the NM node is further configured to receive a notification from the EM, the notification indicating at least one MOI whose operational state is enabled. In another embodiment, the NM node is further configured to resume operational control for deploying the network when the EM has processed all of the information in the file. In another embodiment, each enabled MOI is linked to a corresponding VNF instance.

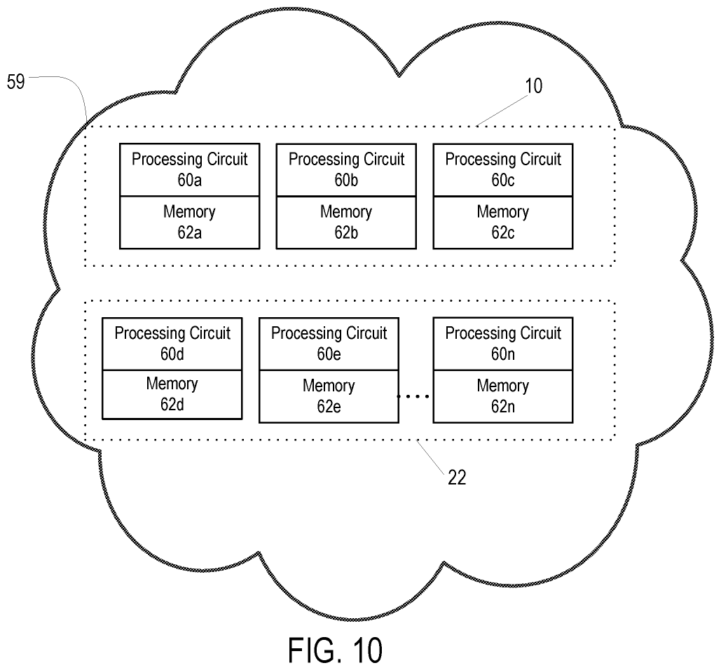

In the embodiments described above, NM 10 and EM 22 are configured to operate in a cloud computing environment 59 such as, for example, the Internet. FIG. 10 is an illustration of a cloud computing environment 59, which includes NM 10 and EM 22. Cloud computing environment 59 may include one or more sets of processing circuits and memory for running the NM 10 and EM 22, where the memory contains instructions executable by the processing circuits. The processing circuits and memory are configured to perform any of the methods disclosed herein. Referring to FIG. 10, cloud computing environment 59 includes NM 10 and EM 22. NM 10 may include, for example, processing circuit 60a and memory 62a, processing circuit 60b and memory 62b and processing circuit 60c and memory 62c. The disclosure is not limited to a specific number of processing circuits and/or memory and thus the illustration in FIG. 10 of three sets of processing circuits and memory in cloud computing environment 59 is merely exemplary and the present disclosure may include any number of processing circuits and corresponding memory.

Similarly, EM 22 may include, for example, processing circuit 60d and memory 62d, processing circuit 60e and memory 62e and processing circuit 60n and memory 62n. Again, the disclosure is not limited to a specific number of processing circuits and/or memory and thus the illustration in FIG. 10 of three sets of processing circuits and memory in cloud computing environment 59 is merely exemplary and the present disclosure may include any number of processing circuits and corresponding memory. Processing circuits 60a to 60n are referred to collectively as “processing circuit 60”. Memory 62a to 62n are referred to collectively as “memory 62”. It is also noted that EM 22 and NM 10 may reside on the same or overlapping processing circuits 60 and memory 62, and thus the separation of EM 22 and NM 10 is FIG. 10 is purely to aid understanding.

According to one aspect, a method, in an EM 22 for deploying vMEs in a network is provided. The method includes receiving, from a NM 10, information that includes a set of VNF IDs, each VNF ID of the set of VNF IDs representing an instantiated VNF 34, each instantiated VNF 34 corresponding to a desired vME (Block S170); receiving, from the NM 10, instructions to deploy the network in accordance with the information (Block S180); creating a set of MOIs based on the information (Block S190); receiving notification when a VNF 34 is instantiated and begins execution, the notification including a corresponding VNF ID (Block S200); and if the corresponding VNF ID matches a VNF ID from the set of VNF IDs: enabling an operational state of an MOI from the set of MOIs corresponding to the matched VNF ID (Block S210).

According to this aspect, in some embodiments, the method further includes notifying the NM 10 of the MOI whose operational state is enabled. In some embodiments, the method further includes returning operational control for deploying the network to the NM 10 when all of the information has been processed. In some embodiments, each enabled MOI is linked to a corresponding VNF 34 instance.

According to another aspect, an EM 22 for deploying vMEs in a network is provided. The EM 22 includes a communications interface 30 and processing circuitry 24. The communications interface 30 is configured to: receive, from a NM 10 information that includes a set VNF IDs, each VNF ID of the set of VNF IDs representing an instantiated VNF 34, each instantiated VNF 34 corresponding to a desired vME; and receive, from the NM 10, instructions to deploy the network in accordance with the information. The processing circuitry 24 is configured to: create a set of MOIs based on the information; and upon the communications interface 30 receiving notification when a VNF is instantiated and begins execution, the notification including a corresponding VNF ID, if the corresponding VNF ID matches a VNF ID from the set of VNF IDs: enable an operational state of an MOI from the set of MOIs corresponding to the matched VNF ID.

According to this aspect, in some embodiments, the processing circuitry 24 is further configured to notify the NM 10, via the communications interface 30, of the MOI whose operational state is enabled. In some embodiments, the processing circuitry 24 is further configured to return operational control for deploying the network to the NM 10 when all of the information has been processed. In some embodiments, each enabled MOI is linked to a corresponding VNF 34 instance.

According to another aspect, a method, in a NM 10, for deploying vMEs in a network is provided. The method includes: requesting a NFVO 38 to instantiate a plurality of VNFs 34, each of the plurality of VNFs 34 corresponding to a desired vME (Block S220); receiving, from the NFVO 38, a set of VNF IDs, each VNF ID of the set of VNF IDs corresponds to an instantiated VNF 34 (Block S230); updating a file by associating the received VNF IDs with corresponding MOIs (Block S240); and instructing an EM 22 to deploy the network based on the information in the file (Block S250).

According to this aspect, in some embodiments, the method further includes receiving a notification from the EM 22, the notification indicating at least one MOI whose operational state is enabled. In some embodiments, each enabled MOI is linked to a corresponding VNF 34 instance. In some embodiments, the method further includes resuming operational control for deploying the network when the EM 22 has processed all of the information in the file.

According to another aspect, a NM 10 for deploying vMEs in a network is provided. The NM 10 includes a communications interface 18 and processing circuitry 12. The communications interface 18 is configured to: request a NFVO 38 to instantiate a plurality of VNFs 34, each of the plurality of VNFs 34 corresponding to each desired vME; and receive, from the NFVO 38, a set of VNF identifications, IDs, each VNF ID of the set of VNF IDs corresponding to an instantiated VNF 34. The processing circuitry 12 is configured to: update a file by associating the received set of VNF IDs with corresponding MOIs; and instruct, via the communications interface 18, an EM 22 to deploy the network based on information in the file.

According to this aspect, in some embodiments, the communications interface 18 is further configured to receive a notification from the EM 22, the notification indicating at least one MOI whose operational state is enabled. In some embodiments, each enabled MOI is linked to a corresponding VNF 34 instance. In some embodiments, the processing circuitry 12 is further configured to resume operational control for deploying the network when the EM 22 has processed all of the information in the file.

According to another aspect, an EM 22 for deploying vMEs in a network is provided. The EM 22 includes a communications interface module 56 and a MOI enabling module 58. The communications interface module 56 is configured to: receive, from a NM 10, information that includes a set of VNF IDs, each VNF ID of the set of VNF IDs representing an instantiated VNF 34, each instantiated VNF 34 corresponding to a desired vME; and receive, from the NM 10, instructions to deploy the network in accordance with the information. The MOI enabling module 58 is configured to create a set of MOIs based on the information; and upon the communications interface module 56 receiving notification when a VNF 34 is instantiated and begins execution, the notification including a corresponding VNF ID, if the corresponding VNF ID matches a VNF ID from the set of VNF IDs: enable an operational state of an MOI from the set of MOIs corresponding to the matched VNF ID.

According to yet another aspect, a NM 10 for deploying vMEs in a network is provided. The NM 10 includes a communications interface module 52 and a VNF ID MOI pairing module 54. The communications interface module 52 is configured to: request a NFVO 38 to instantiate a plurality of VNFs 34, each of the plurality of VNFs 34 corresponding to each desired vME; and receive, from the NFVO 38, a set of VNF IDs, each VNF ID of the set of VNF IDs corresponding to an instantiated VNF 34. The VNF ID MOI pairing module 54 is configured to: update a file by associating the received VNF IDs with corresponding MOIs; and instruct, via the communications interface module 52, an EM 22 to deploy the network based on information in the file.

According to another aspect, an EM node 22, configured to deploy vMEs in a network is provided. The EM node 22 runs in a cloud computing environment 59 and the EM node 22 is configured to: receive, from a NM 10, information that includes a set of VNF IDs, each VNF ID of the set of VNF IDs representing an instantiated VNF 34, each instantiated VNF 34 corresponding to a desired vME; receive, from the NM 10, instructions to deploy the network in accordance with the information; create a set of MOIs based on the information; receive notification when a VNF 34 is instantiated and begins execution, the notification including a corresponding VNF ID; and if the corresponding VNF ID matches a VNF ID from the set of VNF IDs: enable an operational state of an MOI from the set of MOIs corresponding to the matched VNF ID.

According to this aspect, in some embodiments, the EM node 22 is further configured to notify the NM 10 of the MOI whose operational state is enabled. In some embodiments, the EM node 22 is further configured to return operational control for deploying the network to the NM 10 when all of the information has been processed. In some embodiments, each enabled MOI is linked to a corresponding VNF 34 instance.

According to another aspect, a NM node 10 configured to deploy vMEs in a network is provided. The NM node 10 runs in a cloud computing environment 59 and the NM node 10 is configured to: request a NFVO 38 to instantiate a plurality of VNFs 34, each of the plurality of VNFs 34 corresponding to each desired vME; receive, from the NFVO 38, a set of VNF IDs, each VNF ID of the set of VNF IDs corresponding to an instantiated VNF 34; update a file by associating the received VNF IDs with corresponding MOIs; and instruct, via the communications interface, an EM 22 to deploy the network based on information in the file.

According to this aspect, in some embodiments, the NM node 10 is further configured to receive a notification from the EM 22, the notification indicating at least one MOI whose operational state is enabled. In some embodiments, each enabled MOI is linked to a corresponding VNF 34 instance. In some embodiments, the NM node 10 is further configured to resume operational control for deploying the network when the EM 22 has processed all of the information in the file.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby form a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method, in an Element Manager, EM, for deploying virtualized Managed Elements, vMEs, in a network, the method comprising:
receiving, from a Network Manager, NM, information that includes a set of Virtualized Network Function, VNF, identifications, IDs, each VNF ID of the set of VNF IDs representing an instantiated VNF, each instantiated VNF corresponding to a desired vME;
receiving, from the NM, instructions to deploy the network in accordance with the information;
creating a set of Managed Object Instances, MOIs, based on the information;
receiving notification when a VNF is instantiated and begins execution, the notification including a corresponding VNF ID; and
if the corresponding VNF ID matches a VNF ID from the set of VNF IDs:
enabling an operational state of an MOI from the set of MOIs corresponding to the matched VNF ID.

2. The method of claim 1, further comprising notifying the NM of the MOI whose operational state is enabled.

3. The method of claim 1, further comprising returning operational control for deploying the network to the NM when all of the information has been processed.

4. The method of claim 1, wherein each enabled MOI is linked to a corresponding VNF instance.

5. An Element Manager, EM, for deploying virtualized Managed Elements, vMEs, in a network, the EM comprising:
a communications interface configured to:
receive, from a Network Manager, NM, information that includes a set of Virtualized Network Function, VNF, identifications, IDs, each VNF ID of the set of VNF IDs representing an instantiated VNF, each instantiated VNF corresponding to a desired vME; and
receive, from the NM, instructions to deploy the network in accordance with the information; and
processing circuitry configured to:
create a set of Managed Object Instances, MOIs, based on the information; and
upon the communications interface receiving notification when a VNF is instantiated and begins execution, the notification including a corresponding VNF ID,
if the corresponding VNF ID matches a VNF ID from the set of VNF IDs:
enable an operational state of an MOI from the set of MOIs corresponding to the matched VNF ID.

6. The EM of claim 5, wherein the processing circuitry is further configured to notify the NM, via the communications interface, of the MOI whose operational state is enabled.

7. The EM of claim 5, wherein the processing circuitry is further configured to return operational control for deploying the network to the NM when all of the information has been processed.

8. The EM of claim 5, wherein each enabled MOI is linked to a corresponding VNF instance.

9. A method, in a Network Manager, NM, for deploying virtualized Managed Elements, vME, in a network, the method comprising:
requesting a Network Functions Virtualization Orchestrator, NFVO, to instantiate a plurality of Virtualized Network Functions, VNFs, each of the plurality of VNFs corresponding to a desired vME;
receiving, from the NFVO, a set of VNF identifications, IDs, each VNF ID of the set of VNF IDs corresponds to an instantiated VNF;
updating a file by associating the received VNF IDs with corresponding Managed Object Instances, MOIs; and
instructing an Element Manager, EM, to deploy the network based on the information in the file.

10. The method of claim 9, further comprising receiving a notification from the EM, the notification indicating at least one MOI whose operational state is enabled.

11. The method of claim 10, wherein each enabled MOI is linked to a corresponding VNF instance.

12. The method of claim 9, further comprising resuming operational control for deploying the network when the EM has processed all of the information in the file.

13. A Network Manager, NM, for deploying virtualized Managed Elements, vMEs, in a network, the NM comprising:
a communications interface configured to:
request a Network Functions Virtualization Orchestrator, NFVO, to instantiate a plurality of Virtualized Network Functions, VNFs, each of the plurality of VNFs corresponding to a desired vME; and
receive, from the NFVO, a set of VNF identifications, IDs, each VNF ID of the set of VNF IDs corresponding to an instantiated VNF; and
processing circuitry configured to:
update a file by associating the received set of VNF IDs with corresponding Managed Object Instances, MOIs; and
instruct, via the communications interface, an Element Manager, EM, to deploy the network based on information in the file.

14. The NM of claim 13, wherein the communications interface is further configured to receive a notification from the EM, the notification indicating at least one MOI whose operational state is enabled.

15. The NM of claim 14, wherein each enabled MOI is linked to a corresponding VNF instance.

16. The NM of claim 13, wherein the processing circuitry is further configured to resume operational control for deploying the network when the EM has processed all of the information in the file.

17- 26. (canceled)

27. The method of claim 2, further comprising returning operational control for deploying the network to the NM when all of the information has been processed.

28. The method of claim 2, wherein each enabled MOI is linked to a corresponding VNF instance.

29. The method of claim 10, further comprising resuming operational control for deploying the network when the EM has processed all of the information in the file.

30. The method of claim 11, further comprising resuming operational control for deploying the network when the EM has processed all of the information in the file.
